(19) United States
(12) Patent Application Publication
(10) Pub. No.: US 2010/0088148 A1
(43) Pub. Date: Apr. 8, 2010

(54) SYSTEM AND METHODOLOGY FOR RECOMMENDING PURCHASES FOR A SHOPPING INTENT

(76) Inventors: IRFAN PRESSWALA, Sunnyvale, CA (US); ATHELLINA ATHSANI, San Jose, CA (US); CHRIS W. HIGGINS, Portland, OR (US); CHRIS KALABOUKIS, Los Gatos, CA (US); MARC DAVIS, San Francisco, CA (US); CHRISTOPHER T. PARETTI, San Francisco, CA (US); EDWARD STANLEY OTT, IV, Sunnyvale, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/244,121

(22) Filed: Oct. 2, 2008

(51) Int. Cl. G06Q 30/00; G06F 17/30; G06F 17/10

(52) U.S. Cl. 705/10; 701/300; 705/14.1

(57) ABSTRACT

Techniques are disclosed for optimizing shopping. In one aspect, purchase items are recommended to a user based on the total purchasing costs of the recommended purchase items. In one embodiment, the total purchase cost includes not just the price of the purchase item but also includes weighted costs based on non-price purchasing cost factors. In another aspect, data is maintained that represents social relationships between members of a network of users and purchase recommendations are made to a user based on the relatedness between the user, the item and the other members of the network. In yet another aspect, purchase recommendations are made based on the best time to purchase a purchase item. In another aspect, item retailers can offer purchase item incentives to users based on the identity of and information about the shopper to whom the incentive is offered including bundling incentives in a unified redemption code.

### FIELD OF THE INVENTION

The present invention relates generally to shopping, and in particular, to a system and methodology for recommending purchases to shoppers in a manner that optimizes the shopper's experience.

### BACKGROUND

Many consumers make purchasing decisions based on more than just the amount of money that must be paid to the seller/vendor/retailer of a desired good or service. Non-price costs can affect a consumer's purchasing decision to the same extent or even a greater extent than price costs. Non-price costs include any proximate costs connected with a purchase of a purchase item (i.e., good and/or service) such as, for example, external, social, and psychological costs, other than the amount of money the purchaser gives to the seller in order to obtain the purchase item. For example, an environmentally conscious consumer may consider the pollution costs associated with a purchase that others may pay for in some way or at some time in the future but that are not included in the price of the good or service. As another example, a consumer may purchase a good or service from a retailer that is geographically closer to the consumer to save transportation and fuel costs even though the good or service can be obtained for a lower price from another more geographically remote retailer. As yet another example that reflects the psychological costs associated with a purchase, a consumer may be more willing to purchase a particular good or service that has also been previously purchased by a friend or family member.

The advent of the Internet has led to development of online price comparison services that allow shoppers to compare prices for desired goods and services from various retailers. However, many current price comparison services are inadequate for recommending purchases to shoppers because they assume that a shopper is concerned almost exclusively with price when making purchasing decisions. Other deficiencies exist with current online price comparison services. For example, some online price comparison services offer a rating system whereby users can rate their level of satisfaction with a particular good or service or retailer. Often, however, any and all users of the online price comparison service are permitted to provide ratings. Thus, any given rating provides only a general indication of whether the good or service should be recommended to a particular shopper. With many online price comparison services having tens of thousands of users, a rating for a good or service or a rating for a retailer can become so generalized that it becomes practically meaningless to individual shoppers and specific purchasing decisions. Further, many current online price comparison services offer only the ability to “buy now” and do not allow shoppers to time their purchases based on availability of rebates, coupons, etc. to get the most value for their money.

Therefore, there exists a need for a shopping service that is effective for recommending purchases to a shopper in a manner that optimizes the shopper's shopping experience.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of an exemplary client/server environment and mobile network environment in which embodiments of the invention maybe implemented.

FIG. 2 is a flow diagram illustrating a process for recommending purchases for a shopping intent.

FIG. 3A is a block diagram of exemplary user interface components for selecting a shopping intent category and associated bundled purchase items according to an embodiment of the invention.

FIG. 3B is a block diagram of exemplary user interface components for specifying purchase requirements according to an embodiment of the invention.

FIG. 3C is a block diagram of exemplary user interface components for specifying purchase requirements according to an embodiment of the invention.

FIG. 4 is a block diagram of graphical user interface window showing example purchase recommendations made to a shopper according to an embodiment of the invention.

FIG. 5 is a block diagram of a graphical user interface window that shows an example alternative recommended shopping plan according to an embodiment of the invention.

FIG. 6 is a flow diagram of a process for an item retailer to offer a customized incentive to a shopper according to an embodiment of the invention.

FIG. 7 is a diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Systems and methods consistent with the present invention address the needs identified in the background and other needs by providing a shopping service that is capable of recommending purchases based on factors other than current purchase price.

According to one aspect of the invention, purchases are recommended to a shopper based on a calculated total purchasing cost of each recommended purchase item. The calculated total purchasing cost includes not just the price that the shopper must pay to the seller of the purchase item but also a cost value that reflects non-price purchasing costs associated with the purchase. Non-price purchasing costs, or “non-price costs”, are costs associated with a purchase of a particular good or service other than the amount of money the buyer must pay a seller to receive the good or service. Examples of non-price costs include purchase costs to the buyer other than price (e.g., transportation costs to the place of purchase) and external, social, and psychological costs to the buyer and others (e.g., environmental costs).

Various techniques are provided for calculating total purchasing cost based on non-price costs. In one embodiment, the shopper uses a user interface to assign weights to non-price cost factors that the user considers relevant to purchasing decisions and purchase recommendations are made to the shopper based on the assigned weights. Because the shopper's preferences on non-price costs are considered when making recommendations, the recommendations are more relevant to the shopper's purchasing decision than those made by current online price comparison services. In another embodiment, the shopper's user profile is analyzed to derive a set of character attributes that are matched against the aggregated data of all network users to assign a set of default weights for non-price cost factors based upon the weights applied by similar network users whose similarity to the shopper is above a threshold of certainty.

Instead of or in addition making recommendations based on non-price costs, recommendations may be based on discrete social relationships between network members whether explicitly designated by one or both users or derived based upon the number, type, length and topic of communications between the users. Specifically, a database of users is maintained that includes data that represents both explicit and implicit social relationships between the users and recommendations are made based on the data. For example, according to one embodiment, a recommendation to purchase a particular item is made to a shopper based on whether any of the shopper's friends, as indicated by social relationship data, have previously purchased the item. By making recommendations based on discrete social relationships between users, the recommendations can be more relevant to a shopper's purchasing needs than recommendations based on undifferentiated product ratings.

Additionally, techniques are described for making recommendations based on the best time to purchase. These techniques may be used instead of or in addition to the techniques described above for recommending purchases based on total purchasing cost and social relationships. In one embodiment, a message is sent to a shopper that recommends a future time period in which to purchase a recommended purchase item. The recommended future time period is based on the availability of coupons, sales, rebates and the like offered by item retailers. In contrast to the current online price comparison services that offer only the option to “buy now,” the techniques described herein enable shoppers to time their purchases to get the best deals.

According to another aspect of the invention, techniques are disclosed that enable item retailers to offer customized incentives to shoppers in a manner that allows the item retailer to take into account the shopper to whom the incentive is being offered. User profile information about the shopper is presented to the item retailer so that the item retailer can take into account information about the shopper when proposing an offer of an incentive and conditions for obtaining the incentive. The item retailer then provides, based on the user profile information, an offer of an incentive on the purchase item to the user along with one or more incentive conditions that the user must fulfill before receiving the offered incentive. In one embodiment, an item retailer is alerted with a message when a shopper approves a purchase recommendation that includes a purchase item offered for sale by the item retailer so that the item retailer has an opportunity to offer a customized incentive to the shopper. In another embodiment, one or more incentives provided by the item retailers may be bundled with a single unified redemption code.

In addition to other aspects and embodiments of the invention, the foregoing aspects and embodiments discussed in this section will now be described in greater detail.

### Exemplary Client/Server Environment

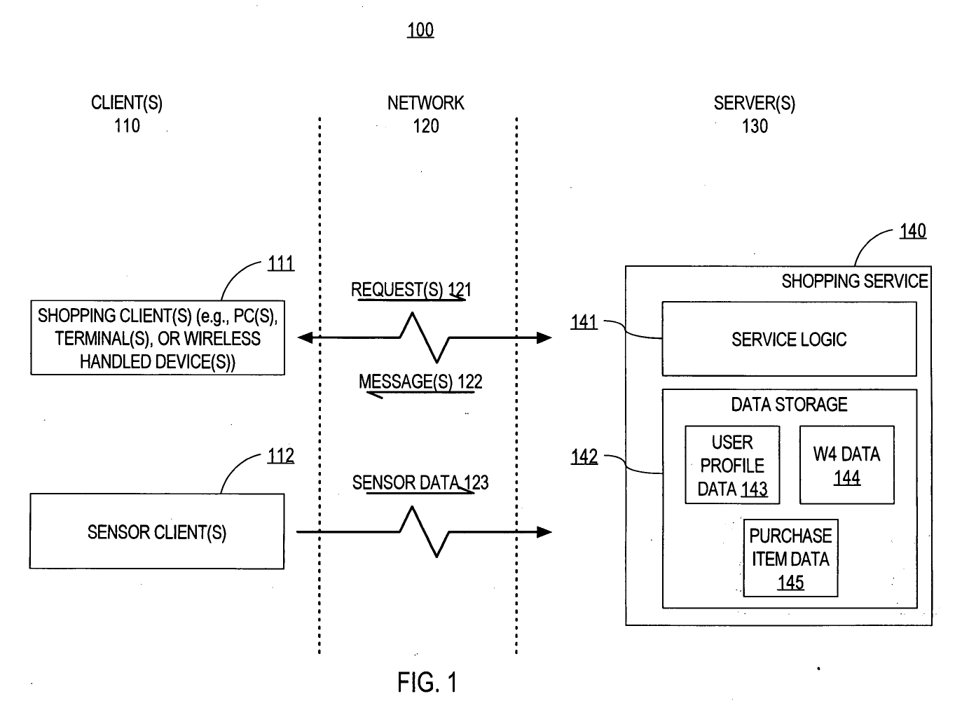

FIG. 1 is a block diagram illustrating an exemplary client/server environment 100 in which embodiments of the invention may be implemented. Environment 100 includes one or more clients 110, data network 120, and one or more servers 130. Client(s) 110 include shopping client(s) 111 and sensor client(s) 112. The one or more server(s) 130 implement shopping service 140. Shopping service 140 offers a network accessible interface for receiving and responding to shopping service request(s) 121 from shopping client(s) 111, sending shopping service message(s) 122 to shopping client(s) 111, and receiving sensor data 123 from sensor client(s) 112.

In environment 100, the server(s) 130 and the client(s) 110 are all coupled to data network 120. The data network 120 facilitates communications between client(s) 110 and server(s) 130. Data network 120 may be any computer network capable of delivering bytes of data, e.g., messages, from one computer, e.g., server 130, to another computer, e.g., client 110. The data network 110 may be a local area network (“LAN”), wide area network (“WAN”) (e.g., the Internet), a telecommunications network, a wireless network, or other functionally equivalent data transfer network system. Further, data network 110 may be comprised of one or more networks that are coupled together to form a single logical network and that supports appropriate network protocol (e.g., TCP/IP for the Internet).

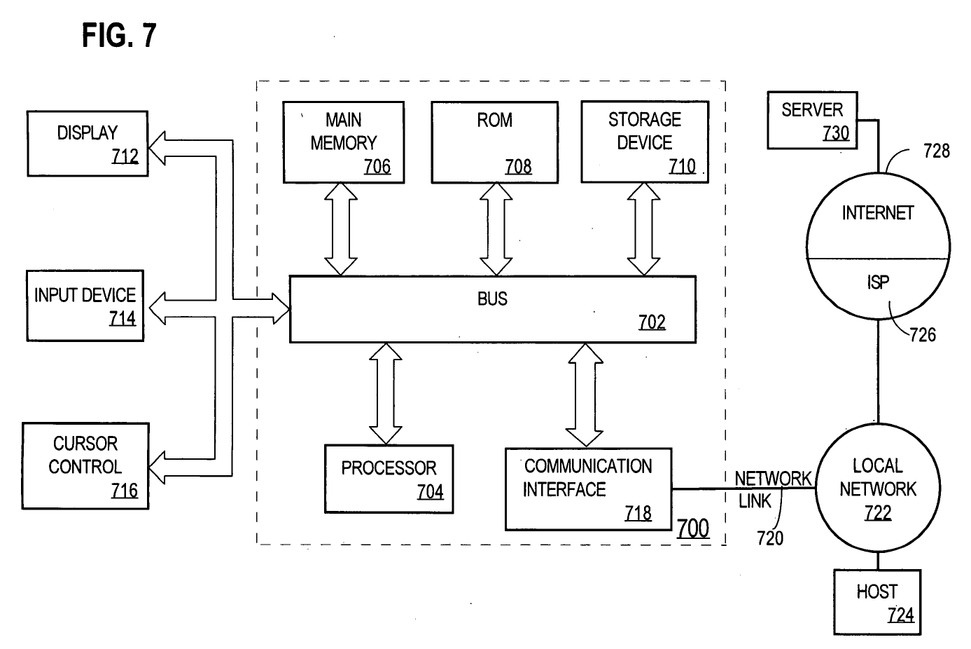

Server(s) 130 may be any combination of software and hardware capable of handling server computer functions, for example, the computer system 700 of FIG. 7. As mentioned above, one or more servers 130 implement shopping service 140. Shopping service may be implemented on a single server 130 or multiple servers 130. Further, in the spirit of distributed computing system architectures, a portion of the functionality provided by shopping service 140, for example service logic 141 or data storage 142, may be implemented on a subset of server(s) 130. Additionally, server(s) 130 may be co-located in a single data center or amongst several, geographically distributed data centers. Further, server(s) 130 may implement other online services such as web page services, messaging services, e-mail services and the like.

Like server(s) 130, client(s) 110 may be any combination of software and hardware capable of handling client computer functions such as the computer system 700 of FIG. 7. Client(s) 110 may include mobile device(s) capable of handling client computer functions within a communications network such as cell phones, smart phones, personal data assistants (PDAs), mobile computers, and the like. Generally, however, mobile device(s) include virtually any portable computing device capable of receiving and sending a message over a network, such as network 120. Mobile device(s) may also be described generally as client devices that are configured to be portable and include virtually any portable computing device capable of connecting to another computing device and receiving or sending information. Thus, one or more embodiments of the invention include a mobile network of online and offline actors and actions, all of which may be modeled to better match and refine purchase recommendations and users shopping at retail locations with the aid of a mobile device can realize the benefits of embodiments of present invention.

As mentioned above, client(s) 110 include shopping client(s) 111 and sensor client(s) 112. Users may employ shopping client 111 to submit shopping service requests 121 over data network 120 to shopping service 140 and to receive shopping service messages 122 from shopping service 140. Shopping service messages 122 refers to both data sent from shopping service 140 to shopping client(s) 111 in response to synchronous requests from shopping client(s) 111 (e.g., a response to a shopping service request 121) and to data that is sent sua sponte (i.e., not in direct response to a synchronous request) from shopping service 140 to shopping client(s) 111 or user(s) thereof (e.g., an e-mail message).

In one embodiment, shopping client 111 is configured with a web browsing application such as the commercially available Microsoft Internet Explorer browser or the Mozilla Firefox browser and the user uses the browsing application to submit requests 121 to and display messages 122 from shopping service 140. Requests 121 and messages 122 may be sent using any network communication protocol or in any data format suitable for sending data over data network 120 such as TCP/IP, Hypertext Transfer Protocol (HTTP), Hypertext Markup Language (HTML), Extensible Markup Language (XML), JavaScript™, Handheld Markup Language (HDML), Wireless Markup Language (WML), WMLScript, Standard Generalized Markup Language (SGML), and the like.

Sensor client(s) 112 each may comprise one or more sensors capable of detecting or measuring a physical quantity and converting the quantity to sensor data 123 which can be sent over data network 120 to shopping service 140. The one or more sensors may be part of sensor client 112 or separate from sensor client 112. For example, road sensors for detecting traffic flow over a stretch of roadway may be installed near or on the roadway and connected via a communications link to a sensor client 112 relatively farther from the roadway which sends sensor data 123 about the roadway to shopping service 140 over data network 120.

A shopping client 111 may also be configured to operate as a sensor client 112 in some aspect. For example, a mobile device such as a cell phone may include a Global Positioning Satellite (GPS) sensor for determining the physical coordinates of the mobile device on the surface of the Earth, which typically outputs a location as latitude and longitude values. Thus, as evidenced by the GPS example, a shopping client 111 may also be a sensor client 112. In one embodiment, however, shopping client 111 may through other components, provide other information that may be employed to determine a physical location of the client, include for example, a MAC address, Internet Protocol (IP) address, or the like.

Sensor client(s) 112 periodically send sensor data 123 to shopping service 140. In one embodiment, shopping service 140 uses sensor data 123 to inform the calculation of a total purchasing cost of a recommended purchase item. For example, given a user's current geographic location as detected by a GPS sensor and the current traffic conditions on the roadways between the user's current location and a retail location as detected by road sensors, shopping service 140 can calculate a total purchasing cost of an item sold at the retail location based on what it would cost the user to drive, for example, in terms of fuel consumed and travel time, from his current location to the retail location.

As mentioned above, shopping service 140 is implemented on one or more servers 130, at least some of which are configured with software and/or hardware based service logic 141 for receiving and responding to shopping service request(s) 121 from shopping client(s) 111, sending shopping service message(s) 122 to shopping client(s) 111, and receiving sensor data 123 from sensor client(s) 112. Shopping service 140 also includes data storage 142 for storing sensor data 123 and storing other data, such as user profile data 143, W4 data 144, and purchase item data 145, which may be needed by service logic 141 to implement aspects of the invention described herein. Data storage 142 may be implemented using any volatile or non-volatile storage medium suitable for storing data.

### User Profile Data

Use profile data 143 may maintain and store, for each user that is a member of a network of users, social network information, including, but not limited to information about the user's personal network of friends, family, colleagues, co-workers, and subsequent connections within the online or offline community. A user's social network typically comprises the user's set of primary and/or indirect personal relationships with other users, including real and virtual privileges and permissions that the user may associate with those other users. Primary relationships are also known as first-degree relationships and usually include relationships with users that the user communicates with directly on a regular basis by telephone, by e-mail, by instant messaging, and the like. In one embodiment, user profile data 143 may maintain information about context-specific primary relationships such as, for example, a user's primary relationship at work and the same user's primary relationship outside of work, or in a social context. Indirect relationships typically include relationships through first-degree relationships to users with whom a user has only had limited direct contact or no direct contact at all. Indirect relationships may be characterized by a degree of separation between users. For instances, a friend of a friend can be characterized as two degrees of separation or a second degree relationship. Similarly, a friend of a friend of a friend can be characterized as three degrees of separation of a third-degree relationship.

In one embodiment, social network information may be obtained directly from a user's address book, buddy list, instant message contacts, or similar source. However, social network information may also be obtained indirectly through monitoring various interactions of a user. Thus, for example, social network information may be extracted based on content of messages between users of a network including, but not limited to e-mail messages, Short Message Service (SMS) messages, Instant Messaging (IM) messages, alerts, audio messages, phone calls, either received or sent by the user, or the like. For example, in one embodiment, the user and another user may include information about a third user in a message, or the like. Such third user information may be obtained, in one embodiment, and stored as part of user profile data 143.

In addition to containing social network information about users, user profile data 143 may also maintain current contact information and associated current location information including a current contact address at which to contact a user at the user's current physical location. The contact address and location information may also be associated with a contact name for the user such as an alias, a user name, or the like. The contact address may include an e-mail address, an IM address, SMS address, a telephone number, IP address, or other information that may be used to establish communication with the user at the user's current physical location. Location information may be obtained from a sensor at the user's physical location such as, for example, a GPS sensor integrated into a mobile device carried by the user. Thus, in one embodiment, contact and location information for a user can be used by shopping service 140 to timely recommend to the user purchase items that are in close physical proximity to the user's current physical location. Alternatively, in another embodiment, if a user is currently at a retail location for which there is a dearth of available inventory information then shopping service 140 can contact the user at the location for an on-the-spot inventory analysis on behalf of another user.

Additionally, data associated with a user's past online or offline activities can be stored as part of user profile data 143 to inform the purchase recommendation process. Past user online activity data includes, for example, websites the user has visited, types of information searched for by the user (search history), types of content download, where the content is downloaded from, and the like. Past user online activity data may include data that reflects previous purchase items recommended to the user according to techniques described herein thereby maintaining a personal shopping history for the user. Past user offline activity data may include physical movements, location tracking, purchases at or visits to retail locations as well as social, temporal and topical metadata associated with those purchases.

### W4 Data

In addition to storing user profile data 143 to inform the process of recommending purchases, data storage 142 may also store W4 data 144. W4 data refers to metadata that indicates the where, when, who, and what properties associated with a real-word event. That is, W4 data 144 may include information about the real-world event which is spatial or geographic in nature (i.e., the “where), temporal (i.e., the “when), social (i.e., the “who”), and/or topical (i.e., the “what”).

According to one or more embodiments, as real-world events occur sensors detect W4 properties associated with the event which are then transmitted by sensor client(s) 112 as sensor data 123 to shopping service 140. Shopping service 140 may then store the transmitted sensor data 123 as W4 data 144 in data storage 142 and associate the W4 data with one or more information objects. An information object refers to data that represents a real-world entity (e.g., a user, retailer, or purchase item) associated with the real-event described by the W4 data.

In addition to receiving W4 data as sensor data 123, W4 data 144 may also be obtained from information contained in shopping service requests 121. For example, in one embodiment, a user may request 123 shopping service 140 to make purchase recommendations while at a particular retail location and shopping service 140 will take into account the user's current presence at the retail location when making recommendations. The user's current presence at the retail location may be detected by a GPS sensor integrated with the mobile device used by the user to make the request 123 of shopping service 140. In this example then, W4 data 144 may be stored that indicates the where (longitude and latitude of the retail location as indicated by the GPS sensor of the mobile device), when (time of request 123), who (the user making request 123), and what (a request for purchase recommendations) that describe the real-world event of the user shopping at the retail location at a particular time. The W4 data 144 may be associated with an information object such as, for example, data that represents the user and/or data that represents the particular retail location.

In general, spatial information may be determined with reference to, for example, location and/or proximity data associated with mobile devices, GPS sensors, Bluetooth and other sensing systems, etc. Temporal information is also widely available in the various systems in which the invention is implemented such as client(s) 110 and/or server(s) 130. Social information may be determined with reference to a wide variety of sources including user profile data 143, and may relate to the user currently enjoying the benefit of the invention such as a user making a request 123, as well as other users with whom the user is communicating, or with whom the user has some form of social relationship as indicated by, for example, user profile data 143. Topical information related to a real-world event is available from a variety of sources including, but not limited to, the content of the requests 123 and messages 122, the content of communications between users such as by e-mail or instant messaging, as well as explicit profile data (such as declared interests) expressed in user profile.

### Total Cost Calculator

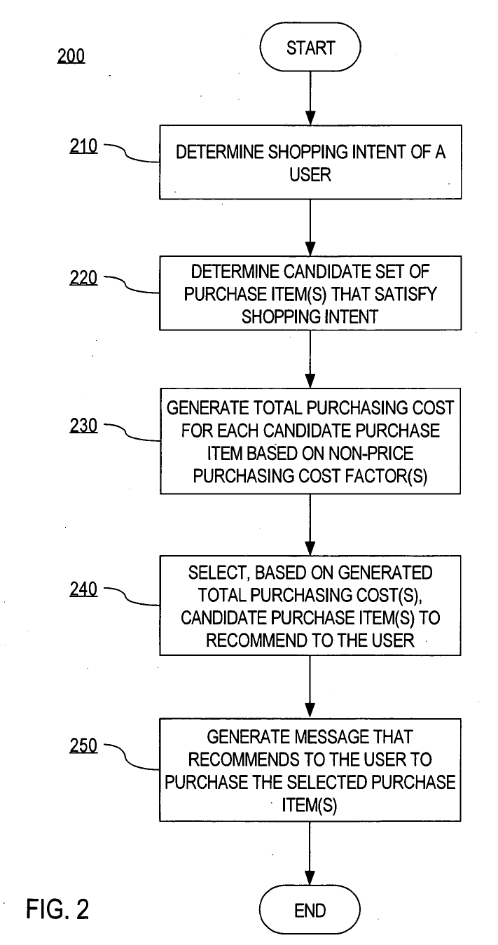

According to one or more embodiments, purchase items are recommended to a user based on a total purchasing cost of each purchase item which includes non-price costs associated with the purchase item. FIG. 2 is a flow diagram which illustrates a high level process 200 for recommending purchase items to a user based on total purchasing cost. In one or more embodiments, process 200 is implemented by service logic 141 of shopping service 140.

Process 200 begins after a start block, at block 210, where a user's shopping intent is determined by shopping service 140.

### Shopping Intent

A used herein, the term “shopping intent” refers to criteria used by shopping service 140 to determine purchase items to recommend to a user that meet the user's shopping needs, wants, and desires as expressed by the criteria. Shopping intent criteria may be specified in a user's request 121 to shopping service 140 and/or may be inferred by shopping service 140 from a user's specified shopping intent in a request 121, from user profile data 143 associated with the user and/or from W4 data 144.

In one or more embodiments, to specify a shopping intent, the user enters one or more words, terms, or keywords (i.e., “shopping query”) into a user interface that is presented to the user by shopping service 140 at shopping client 111. The user then sends the shopping query in a request 121 to shopping service 140. Upon receiving a shopping query, shopping service 140 searches for one or more candidate purchase items that satisfy the shopping query in a purchase item database such as purchase item data 145 in data storage 142.

In addition to or instead of specifying a shopping intent with a shopping query, the user may specify a shopping intent by selecting a shopping intent category from a list of categories. Each shopping intent category may contain subcategories that each offers a suggested set of bundled purchase items. The user may select specific purchase items from the bundles and/or select one or more bundles in their entirety. The list of shopping intent categories and subcategories may be presented to the user at a shopping client 111 by shopping service 140. Data that represents the set of available shopping intent categories and subcategories may be maintained by shopping service 140 in data storage 142.

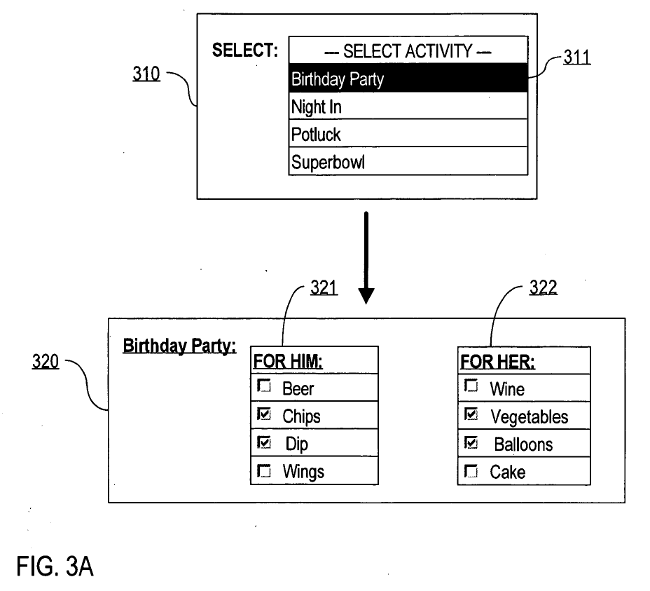

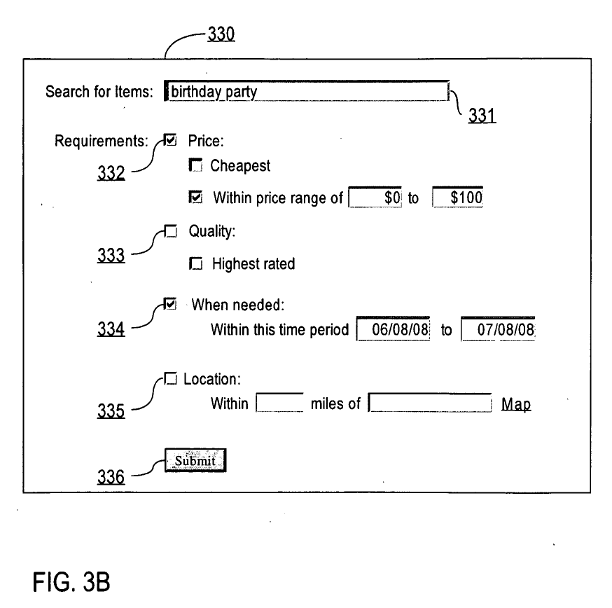

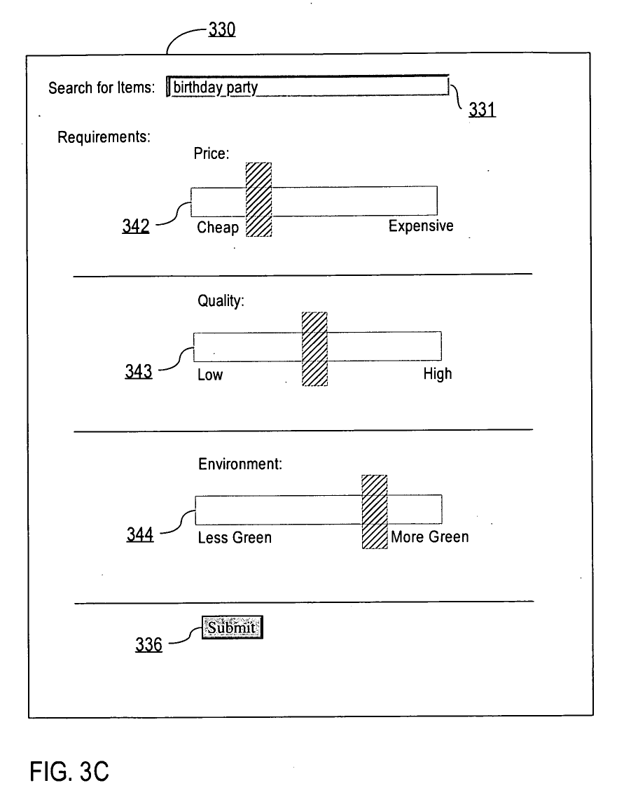

FIG. 3A is a block diagram of exemplary user interface components for selecting a shopping intent category and associated bundled purchase items according to an embodiment of the invention. A user interface that is caused to be presented to a user at shopping client 111 by shopping service 140 may include user interface component 310 for selecting a shopping intent category and user interface component 320 for selecting one or more bundled items from shopping intent subcategories 321 and 322.

In the example illustrated by FIG. 3A, the shopping intent category “Birthday Party” is selected from user interface component 310 which causes shopping intent subcategories “From Him” and “For Her” of shopping intent category “Birthday Party” to be presented to the user. Shopping intent subcategory 321 contains a list of selectable bundled purchase items related to shopping for a birthday party “for him.” Shopping intent subcategory 322 contains a list of selectable bundled purchase items related to shopping for a birthday party “for her.” The user may select one or more purchase items from the bundled purchase items presented in shopping intent subcategories 321 and 322.

The list of shopping intent categories, subcategories, and bundled purchase items available for selection in components 310 and 320 may be based on a predefined list of categories/purchase items and/or may be based on user profile data 143 and/or W4 data 144. For example, if a user has provided valid authentication credentials to shopping service 140 then the identity of the user may be ascertained by shopping service 140 when presenting user interface components 310 and 320 to the user. Shopping service 140 then may customize the lists of shopping intent categories/subcategories/bundled purchase items presented in components 310 and 320 based on the identity of the user to whom the list is being presented to. The lists may be customized based on user profile data 143 and/or W4 data associated with the user such as the user's social network information, current contact information, current location information, and past online or offline activity data, search history, past purchase recommendations, etc.

In addition to specifying shopping intent criteria through a shopping query and/or a shopping intent category, the user may specify purchase requirements as part of specifying a shopping intent. FIG. 3B is a block diagram of exemplary user interface components for specifying purchase requirements according to an embodiment of the invention. Graphical user interface window 330 includes a search field 331 for entering a shopping query and purchase requirement controls 332-335 which the user can selectively enable or disable by selecting the checkbox associated with the purchase requirement. In one embodiment, graphical user interface window 330 is a browser window that is caused to be displayed by shopping service 140 on the display of a shopping client 111.

Purchase requirement controls 332-335 may reflect virtually any price and/or non-price purchasing cost factor that may be relevant to users when making purchasing decisions. By specifying purchase requirements in a shopping intent, a user can constrain the types of purchase items that shopping service 140 recommends to the user. For example, the user may constrain purchase recommendations to purchase items that are available for purchase during a certain time period by specifying the time period when the purchase items are needed.

In addition to allowing the user to constrain the types of purchase items that shopping service 140 recommends to the user, shopping service 140 may use the purchase requirements to calculate the total purchasing cost of a purchase item with respect to non-price purchasing cost factors. For example, FIG. 3B shows three example non-price purchasing cost factors: purchase item quality, purchase item time period, and purchase item location. In one embodiment, purchase item quality refers to a cost to the buyer of purchasing an inferior purchase item relative to the most superior purchase item in a class of purchase items. This cost may be measured in a number of ways including by comparing and quantifying the difference in purchase item rating between the highest rated purchase item in a class of purchase items with a particular purchase item that is a member of the same class of purchase items. For example, assume shopping service 140 maintains data that reflects purchase item ratings from users about high-definition televisions. The cost with respect to purchase item quality of a particular high-definition television from a particular vendor can be measured by quantifying the rating difference between the particular high-definition television and the rating of the highest rated high-definition television in the class of high-definition televisions of which the particular high-definition television is a member.

In one embodiment, purchase item time period refers to the cost associated with purchasing a particular purchase item during specified period of time (or now if no time period is specified). This cost may be measured relative to the cost to purchase the particular purchase item during other time periods such as, for example, when the purchase item is on sale.

In one embodiment, purchase item location refers to the cost associated with traveling to the retail location where a particular purchase item is sold. This cost includes transportation costs and travel time to the retail location.

Other non-price purchasing cost factors include purchase item sourcing and purchase item relatedness. In one embodiment, purchase item sourcing includes any data on the manufacturer and supply/retail chains of purchase items from creation to consumption by users and include business practices, social and political affiliations or policies, benefits given to employees, partners and their communities. Examples of purchase item sourcing data include data about which retailers give to political action committees or candidates that the user does or does not support, or which retailers are associated with child labor, etc.

In one embodiment, purchase item relatedness is in any dimension of spatial, temporal, social or topical data between the user and a purchase item including: proximity of the item to the user during the user's daily life (e.g. next door neighbor owns the same car), proximity of a known social relation who has purchased, research or considered the item, proximity of your interest to an attribute of the item and the proximity in time to any other influencing factor for its relation to the user.

Returning to the example illustrated by FIG. 3B, the user has entered the shopping query “birthday party” into the search field 331. Further, the user has selected two purchase requirements, price and the time period when the items are needed. The price purchase requirement control 332 indicates that the user is interested in purchase items that cost no more than $100. The time period purchase requirement control 334 corresponds to the non-price purchasing cost factor purchase item time period. The user has indicated for purchase item period a time period of Jun. 8, 2008 to Jul. 8, 2008. The user may then submit the shopping query and the purchase requirements in a request 121 to shopping service 140 by selecting the submit button 336.

In addition to or instead of specifying purchase requirements using the user interface controls illustrated in FIG. 3B, the user interface controls of FIG. 3C may also be used. FIG. 3C is a block diagram of exemplary user interface components for specifying purchase requirements according to an embodiment of the invention. FIG. 3C shows graphical user interface window 330 including search field 331 and purchase requirement controls 342, 343, and 344. Purchase requirement controls 342, 343, and 344 are slider controls which the user can slide in a direction to indicate the importance of the corresponding purchase requirement to the user when making purchasing decisions. For example, a user could slide purchase requirement control 334 labeled “environment” to the right to indicate that the user is interested in purchase items that are relatively more environmentally friendly.

Like purchase requirement controls 333, 334, and 335 of FIG. 3B, controls 342, 343, and 344 of FIG. 3C may reflect non-price purchasing cost factors that shopping service 140 may use to calculate a total purchase cost for recommended purchase items. Specifically, the user may use slider controls 342, 343, and 344 to assign weights to non-price purchasing cost factors. For example, in FIG. 3C, the user, by sliding control 344 farther to the right than control 343 has indicated that a relatively greater weight should be given to the environmental friendliness of purchase items rather than the quality of purchase items. In other words, when shopping service 140 calculates the total purchasing cost of purchase items that are equal in cost all other respects except quality and environmental friendliness, the incentive in cost of a purchase item that is relatively more environmentally friendly will be greater than the incentive in cost for the same relative superior quality. Once the user has set the purchase requirement controls 342, 343, and 344 and entered a shopping query into field 331, the user may submit the shopping query and submit the weights assigned to the purchase requirements in a request 121 to shopping service 140 by selecting the submit button 336.

The user interface controls and components depicted in FIGS. 3A, 3B, and 3C are exemplary only and embodiments of the invention are not limited to any particular type of user interface control. Further, embodiments are not limited to the number or arrangement of purchase requirement controls shown in FIGS. 3A, 3B, and 3C. Also, purchase requirement controls 333-335 and slider controls 342-344 may be presented to the user in the same window 330. For example, graphical user interface window 330 may contain purchase requirement controls 334 and 335 of FIG. 3B and purchase requirement controls 343 and 344 of FIG. 3C.

As well as specifying a shopping intent in a request 121 to shopping service 140, shopping service 140 may infer some or all of a user's shopping intent. A shopping intent inference by shopping service 140 represents a context based guess on the shopping intent of a user. The context may be provided by criteria specified in a request 121 that includes shopping intent criteria information such as a shopping query and/or purchase requirements. The context may also be provided by user profile data 143 and/or W4 data 144. For example, the user's current location information as indicated by user profile data 143 associated with the user can be used by shopping service 140 to infer a purchase item location purchase requirement such as, for example, that the user is interested in purchase items that are available for purchase within a certain distance from the user's current location.

Returning to FIG. 2, process 200 continues at block 220 where a candidate set of purchase items is determined by shopping service 140 that satisfy the shopping intent determined in step 210. In general, step 220 involves shopping service 140 evaluating the specified and inferred shopping intent criteria against purchase item data stored in a database of purchase items, such as purchase item data 145 stored in data storage 142, and selecting purchase items that match the criteria.

In step 230 of process 200, a total purchasing cost is calculated for each purchase item of the candidate set determined in step 220 and at block 240 one or more candidate purchase items are selected as purchase items to recommend to the user. In step 250, shopping service 140 generates a message that recommends to the user to purchase the selected purchase items.

### Calculating Total Purchasing Cost

In one embodiment, the total cost of a purchase item is calculated as the “W4 distance” to a retail location where a particular candidate purchases item is available for purchase. In general, the W4 distance is the cost of traveling to a retail location modified by weighted non-price purchasing cost factors along spatial, temporal, social, and topical axes. Weighting factors can be positive or negative and the weighting factors themselves can be modified (or weighted) according to the source and their relation to the requesting user, but in effect, they either modify the W4 distance to increase it or decrease it.

In an embodiment, a route to a retail location is graphed against the W4 data 144 and/or user profile data 143 associated with the user and/or the retail location to create a W4 distance calculation to the retail location using spatial, temporal, social and topical data for those locations as well as associated or related data. The actual spatial distance is then modified by weighting factors for each of the other types of data: social, temporal and topical. The locations and/or routing can then be displayed in such a way to represent the W4 distance and not just the spatial distance between the locations and or users.

### Purchase Recommendation Example

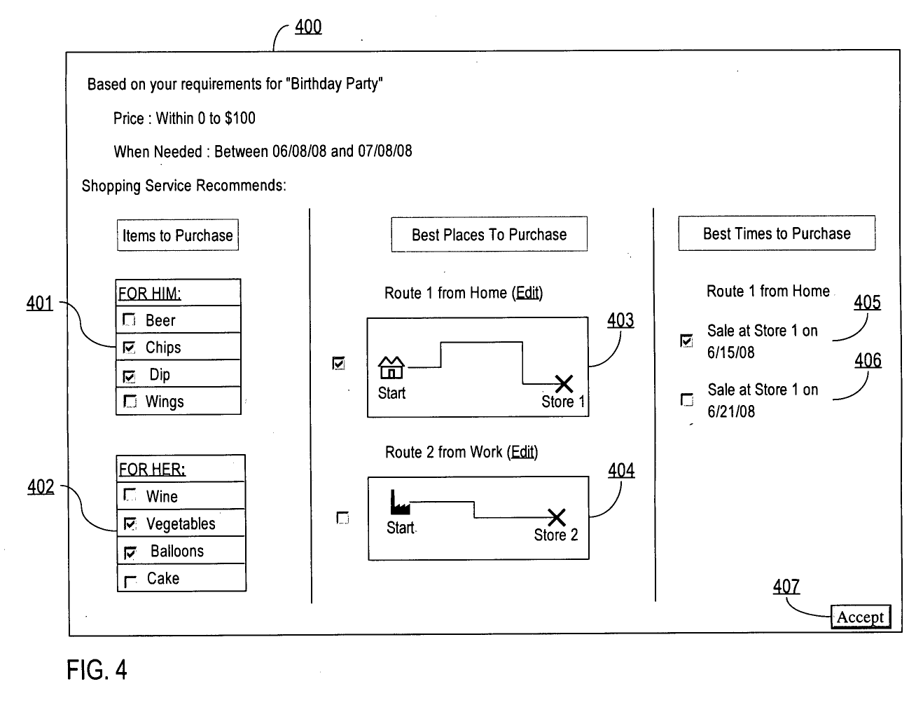

FIG. 4 is a block diagram of graphical user interface window 400 showing example purchase recommendations made to a shopper according to an embodiment of the invention. In one embodiment, window 400 is displayed to a user at a shopping client 111 in response to the user specifying a shopping intent in a request 121 to shopping service 140. In the example, the user has submitted in the request 121 a shopping query of “birthday party” and further submitted in the request a purchase requirement that all purchase items be no more than $100 and a purchase item time period requirement that the purchase items be available for purchase from Jun. 8, 2008 to Jul. 8, 2008.

Upon receiving this request, shopping service 140 may infer additional purchase requirements such as, for example, the locations from which the user most likely will depart from on a shopping trip to purchase recommended purchase items. These locations may be determined, for example, from user profile data 143 and/or W4 data 144. Assume, for the purposes of explanation, that the user profile data 143 associated with the user contains information about the user's home address and the user's work address. In one embodiment, once shopping service 140 has determined the user's shopping intent including likely departure locations, shopping service 140 may select purchase items to recommend based on which purchase items are available at retail locations close to the user's likely departure locations.

Accordingly, in FIG. 4, the purchase items 401 and 402 that are recommended to the user are available for purchase at “Store 1” and “Store 2” indicated on direction maps 403 and 404 respectively, direction map 403 providing directions from the user's home to “Store 1”, and direction map 404 providing directions from the user's work to “Store 2”. Furthermore, the purchase items 401 and 402 may be recommended to the user based on the W4 distance between, for example, the user's home and work and Store 1 and Store 2 respectively. As explained above, the W4 distance takes into account costs other than travel and price costs associated with purchasing items at a particular retail location. Thus, “Store 1”, for example, may not be the closest retail location to the user's home where the recommended purchase items may be purchased but instead may be the purchase location that sells a recommended purchase item that satisfies a non-price and non-travel aspect of the user's shopping intent such as, for example, eco-friendliness.

Additionally, the purchase recommendations shown in window 400 provide suggested best times 405 and 406 to purchase the recommendation purchase items 401 and 402. The suggested times may be based on a variety of factors including such factors as when particular retail locations are conducting a sale of recommended purchase items and/or when conditions for traveling along the suggested routes are most favorable (e.g., historically low traffic times, etc).

In one embodiment, one or more purchase items are recommended in a purchase item bundle and the bundle is associated with a unified redemption code. The unified redemption code can act as a proxy for each of the bundled purchase items and may be used to refer to the bundle either at a retail location and/or online. In cases where a bundle contains purchase items offered by different retailers then the unified redemption code can refer to the purchase items at each retail location and/or at each retailer's web site. In one embodiment, the unified redemption code is a Universal Product Code (UPC) like symbology and alpha-numeric code that may be scanned at a retail location and/or input online to refer to the purchase items of a bundle. In one embodiment, the purchase items are associated with incentives from item retailers and the unified redemption code associated with a bundle refers additionally to the incentives associated with the purchase items of the bundle. As used herein, an “incentive” refers to monetary incentives from retailer such as price discounts, etc. and non-monetary incentives from retailers such as points, loyalty programs, etc.

### Accepting a Shopping Plan

In one embodiment, when presented with alternative purchase recommendations, the user may select one of the alternatives to accept as a shopping plan. The accepted shopping plan may then be stored as part of user profile data 143 associated with the user that accepted the shopping plan. The user then may view and edit accepted and stored shopping plans at a later time. Additionally, shopping service 140 may take various actions on stored shopping plans such as, for example, sending e-mail messages to the user reminding the user of upcoming best times to purchase recommended purchase items. Further, shopping service 140 may use the stored shopping plans of a user to infer the shopping intent of a user and/or to determine which candidate purchase items to select as purchase recommendations for the user.

Returning to FIG. 4, to accept a shopping plan, the user may select one or more purchase items 401 and 402, a travel route 403 or 404, and a time to purchase 405 or 406. In the example depicted in FIG. 4, the user has selected purchase items “Chips”, “Dip”, “Vegetables”, and “Balloons” from the purchase item bundles 401 and 402. Further, the user has selected “Route 1” from the user's home to “Store 1” and selected “6/15/08” as a time to purchase the selected purchase items. Upon selecting accept button 407, the user's selected shopping plan is sent in a request 121 to shopping service 140 which, upon receiving the request 121, may store the user's accepted shopping plan in data storage 142.

### Alternative Shopping Plan

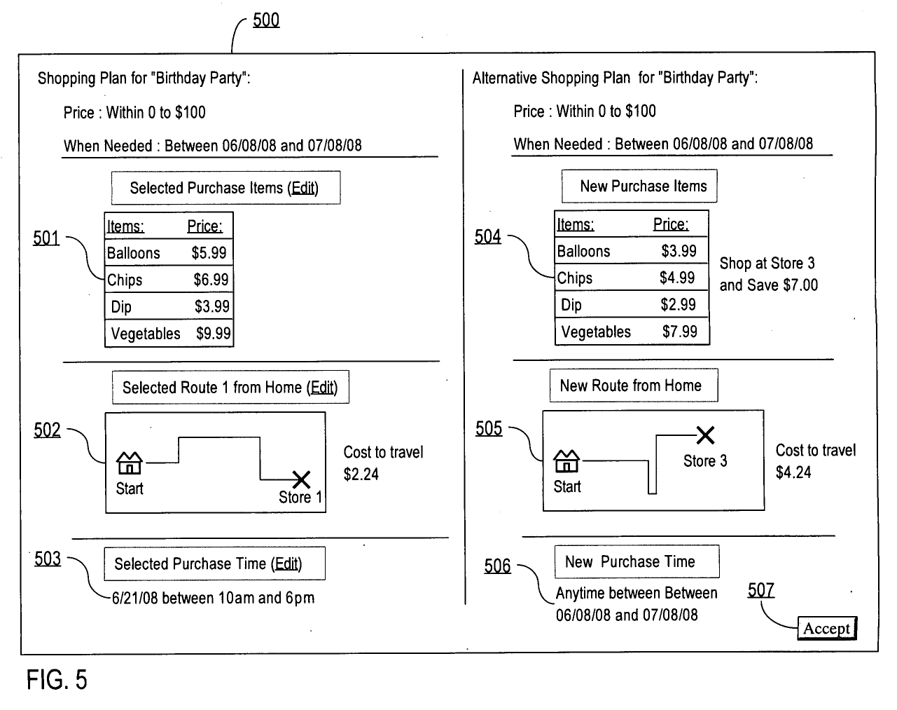

As well as storing a user's accepted shopping plan, shopping service 140, in response to receiving a request 121 to accept a user's shopping plan may recommend an alternative shopping plan. The alternative shopping plan satisfies the user's shopping intent and may recommend purchase items with a lower total purchasing cost than the purchase items accepted in the user's current shopping plan. FIG. 5 is a block diagram of a graphical user interface window 500 that shows an alternative recommended shopping plan according to an embodiment of the invention. In the example depicted by FIG. 5, window 500 is displayed by shopping service 140 in response to the user accepting the shopping plan selected using window 400 of FIG. 4. The left side of window 500 shows the user's current shopping plan including selected purchase items 501, selected route 502, and selected purchase time 503. The right side of window 500 shows an alternative shopping plan including new recommended purchase items 504, new route 505, and new purchase time 506.

In one embodiment, shopping service 140 determines the alternative shopping plan to recommend to the user based on the calculated W4 distances of the user's current shopping plan and the alternative shopping plan. In particular, once the user has accepted a shopping plan that includes a departure location, for example the user's home of the current shopping plan illustrated in FIG. 5, then shopping service 140 can determine alternative purchase locations from the same departure location that satisfy the user's shopping intent. For example, FIG. 5 shows an alternative shopping plan that includes a new purchase location, Store 3, at which the user can purchase the selected purchase items. The cost to travel to Store 3, as calculated by shopping service 140 according to the W4 distance calculation described above, is $2.00 more than the cost to travel to Store 1. However, the selected purchase items can be purchased at Store 3 for $7.00 less than at Store 1. Further, the user is informed that the selected purchase items can be purchased at Store 3 at the indicated prices throughout the time period specified by the user in the user's shopping intent. Thus, the total purchasing cost of the purchase items of the alternative shopping plan is lower than total purchasing cost of the purchase items in the user's currently accepted shopping plan as measured by the corresponding W4 distances. The user may accept the alternative shopping plan as a replacement to the currently accepted shopping plan by selecting the accept button 507.

Comparing an alternative shopping plan with the currently accepted shopping plan based on W4 distance is not limited to the factors in the example of FIG. 5 and may include other W4 distance factors along temporal, spatial, social, and topical axes. For example, shopping service 140 may recommend alternative purchase items that, based on a W4 distance calculation, are more environmentally friendly.

### Purchase Recommendations Based on Social Relationships

In one embodiment, the W4 distance calculation includes modifying the actual spatial distance between a departure location and a purchase location based on a weighted social factor. The social factor may be based on data that represents discrete social relationships between the particular user to whom the purchase recommendation is being made and other users of a community of users of which the particular user is a member. Specifically, shopping service 140 may maintain social network information of user profile data 143 that represents social relationships between the users and shopping service 140 may make recommendations based on the social network information. For example, in one embodiment, a recommendation to purchase a particular item is made to a shopper based on whether any of the shopper's friends, as indicated by social relationship data, have previously purchased the item.

An indication that a friend of the user has purchased a particular recommended purchase item may be displayed to the user by shopping service 140 when making a purchase recommendation. For example, the indication may be displayed on window 400 of FIG. 4 or as part of an alternative shopping plan such as the one displayed in window 500 of FIG. 5. In one embodiment, the indication specifies whether the friend has a direct relationship or an indirect relationship with the user, and if an indirect relationship, the degree of separation between the user and the friend.

### Purchase Recommendations Based on Best Time to Purchase

In one embodiment, shopping service 140 makes purchase recommendations based on the best time to purchase a recommended purchase item at a particular retail location. Initially, shopping service 140 determines a shopping intent of a user as in step 210 of process 200. Then shopping service 140 identifies a purchase item that satisfies the shopping intent as in step 220 of process 200. Shopping service 140 then determines a first cost value that represents the cost of purchasing the purchase item from a particular retail location during a first period of time. In one embodiment, the first cost value is the W4 distance associated with purchasing the identified purchase item from the particular retail location during the first period of time. The first period of time may be a period of time specified in the shopping intent such as, for example, the purchase item time period specified by a user in the example illustrated by FIG. 4. Alternatively, the first time period may be a default time period such as a default time period that corresponds with a shopping intent to purchase immediately or as soon as possible.

After determining a first cost value, shopping service 140 then determines a second cost value that represents the cost of purchasing the purchase item from the particular retail location during a second period of time. In one embodiment, the second cost value is the W4 distance associated with purchasing the identified purchase item from the particular retail location during the second period of time. The second period of time may be any period of time that falls within the user's specified purchase item time period or within the default time period. For example, the second period of time may be a period of time during which the retail location is offering an incentive or sale on the identified purchase item.

After determining a second cost value, shopping service 140 then determines a recommend time period based on the first cost value and the second cost value. In general, if the first cost value is lower than the second cost value, then shopping service 140 recommends the first time period. If the second cost value is lower than the first cost value, then shopping service 140 recommends the second time period.

After determining a recommend time period, shopping service 140 then sends a message 122 to the user recommending the user to purchase the particular purchase item from the particular retail location during the recommended time period. In one embodiment, the message is returned in response to the user specifying a shopping intent such as the best times to purchase message included in window 400 of FIG. 4. In another embodiment, the message is returned in response to the user accepting a shopping plan such as the alternative shopping plan shown in window 500 of FIG. 5. In yet another embodiment, the message is an e-mail message that is sent to the user to inform the user of the recommended time period.

In one embodiment, the recommended time period is a time period in the future relative to when the message containing the recommend time period was sent to the user. In this way, shopping service 140 can make a purchase recommendation based on the expected future availability of couples, sales, incentives, etc. offered by item retailers.

### Customized Incentives from Item Retailers

In one embodiment, shopping service 140 enables item retailers to offer customized incentives to shoppers in a manner that allows the item retailer to take into account the shopper to whom the incentive is being offered. User profile information about the shopper is presented to the item retailer so that the item retailer can take into account information about the shopper when proposing an offer of an incentive and conditions for obtaining the incentive. The item retailer then provides, based on the user profile information, an offer of an incentive on the purchase item to the user along with one or more incentive conditions that the user must fulfill before receiving the offered incentive.

In one embodiment, an item retailer is alerted with a message when a shopper accepts a shopping plan that includes a purchase item offered for sale by the item retailer so that the item retailer has an opportunity to offer a customized incentive to the shopper.

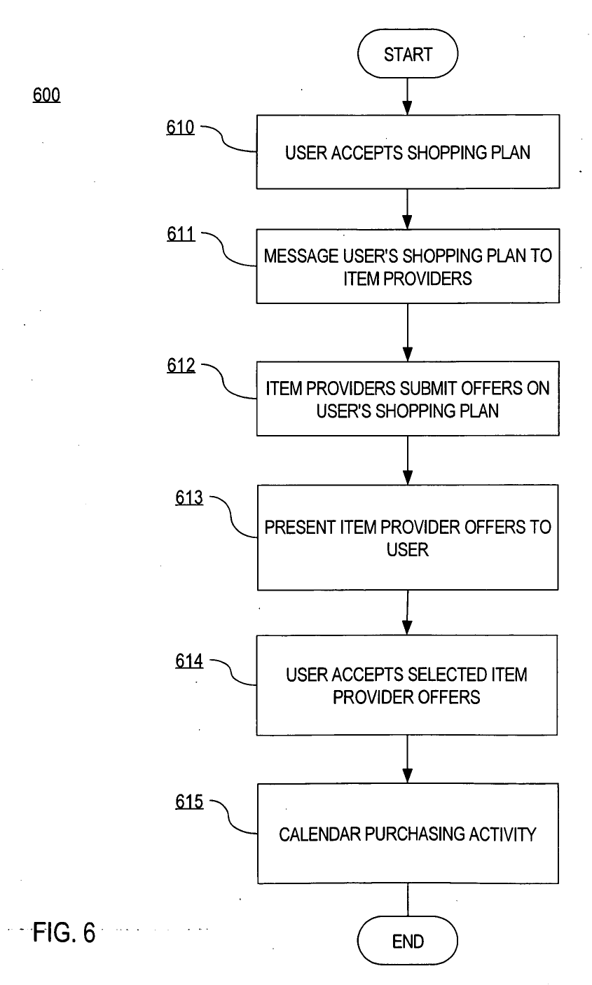

FIG. 6 is a flow diagram of a process 600 for an item retailer to offer a customized incentive to a shopper according to an embodiment of the invention. Process 600 begins at step 610 where a user accepts a shopping plan as described above. Process 600 then continues at step 611 where shopping service 140 messages selected item retailers about the user's acceptance of a shopping plan. Which item retailers shopping service 140 messages can be based on a variety of factors including, for example, the types of purchase items the user accepted in the shopping plan. For example, shopping service 140 may notify a shoe retailer anytime a user accepts a shopping plan that includes a purchase item related to shoes. In one embodiment, shopping service 140 provides a registration service whereby item retailers can register their interest in accepted shopping plans. According to the embodiment, the item retailer specifies criteria that shopping service 140 compares to each accepted shopping plan and determines whether the criteria matches the accepted shopping plan. If there is a match, then shopping service 140 messages the item retailer about the match. The criteria can be based upon virtually any aspect of an accepted shopping plan such as the purchase items accepted and the purchase requirements of the shopping intent that corresponds to the accepted shopping plan. Additionally, the criteria may be based on user profile data 143 and/or W4 data 144 associated with the accepted shopping plan. Thus, for example, an item retailer could specify criteria to request a message when a user is within a certain proximity to the item retailer's retail location as indicated by, for example, GPS sensor data.

The message received by an item retailer may include any information about the accepted shopping plan including user profile information of the user that accepted the shopping plan. By including such information the item retailer can make an informed offer of an incentive to the user. While the item retailer would prefer more information about the user and the accepted shopping plan when formulating an offer of an incentive, the user may wish to prevent the item retailer from knowing certain information about the user and/or the accepted shopping plan. Thus, in one embodiment, shopping service 140 allows the user to configure what types of information are included and excluded from messages sent to item retailers informing the item retailers about the user's accepted shopping plans. The type of information that may be included or excluded include aspects of the user's user profile data 144 and/or aspects of the user's accepted shopping plan.

After an item retailer receives a message notifying of a user's accepted shopping plan, process 600 continues at step 613 where the item retailer submits an offer of an incentive to shopping service 140 on at least one of the purchase items accepted by the user in the shopping plan. The offer may be accompanied by one or more conditions that the user must agree to in order to accept the incentive. For example, the item retailer may offer an incentive on a purchase item as part of a bundle of purchase items and the user must purchase the bundle in order to receive the incentive.

After an item retailer makes an offer of an incentive, process 600 continues at step 614 where the user is presented with the offer of an incentive by shopping service 140 and the user can either accept or reject the offer. If the user accepts the offer then the shopping plan is modified to reflect the accepted offer.

In optional step 615, shopping service 140 calendars aspects of the shopping plan that are scheduled to occur in the future such as purchase item periods and/or when time periods when the incentive is in effect or can be redeemed. Shopping service 140 may store calendaring data in data storage 142. In one embodiment, shopping service 140 sends e-mail remainders to users as calendared events approach.

### Basic Hardware Implementation (e.g., for Client and Server Computers)

Client(s) 110 and server(s) 130 may comprise a conventional or general-purpose computer system, such as an IBM-compatible personal computer (PC) or server computer. FIG. 7 is a very general block diagram that illustrates a computer system 700 in which software-implemented processes of the present invention may be embodied. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

The invention is related to the use of computer system 700 for implementing the techniques described herein. According to one embodiment of the invention, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 700, various machine-readable media are involved, for example, in providing instructions to processor 704 for execution. Such a medium may take many forms, including but not limited to storage media and transmission media. Storage media includes both non-volatile media and volatile media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

IBM-compatible personal computers and server computers are available from a variety of vendors. Representative vendors include Dell Computer of Round Rock, Tex., Hewlett-Packard of Palo Alto, Calif., and IBM of Armonk, N.Y. Other suitable computers include Apple compatible computers (e.g., Macintosh), which are available from Apple Computer of Cupertino, Calif., and Sun Solaris workstations, which are available from Sun Microsystems of Mountain View, Calif.

### CONCLUSIONS

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A machine implemented method for recommending purchases, the method comprising:
determining a shopping intent of a user;
determining a candidate set of purchase items that satisfy said shopping intent;
generating a total purchasing cost for each purchase item in the candidate set, wherein the total purchasing cost of each purchase item is based on a set of one or more non-price purchasing cost factors;
wherein the set of one or more non-price purchasing cost factors do not affect how much the user has to pay at the point of sale for the purchase items;
based on the total purchasing costs generated for the purchase items in the candidate set, selecting one or more purchase items, from the candidate set of purchase items, to recommend to the user; and
generating a message that recommends to the user to purchase the selected one or more purchase items;
wherein the method is performed by one or more computing devices.

2. The method of claim 1 further comprising:
determining an indication of weights assigned to one or more non-price purchasing cost factors of the set of non-price purchasing cost factors; and
wherein the step of generating a total purchasing cost for each purchase item in the candidate set is based on the assigned weights.

3. The method of claim 2 wherein the one or more non-price purchasing cost factors that are assigned weights by the user are selected from the group consisting of purchase item quality, purchase item time period, purchase item environmental impact, purchase item sourcing, purchase item relatedness, and purchase item location.

4. The method of claim 2 wherein at least one of the weights is assigned by a user through graphical user interface controls that are caused to be presented to the user at a client.

5. The method of claim 1 wherein determining a shopping intent of a user comprises:
determining at least a portion of the shopping intent based on data that represents purchase items previously related to the user.

6. The method of claim 1 wherein determining a shopping intent of a user comprises:
receiving at least a portion of the shopping intent in a request from the user.

7. The method of claim 6 further comprising:
deriving at least a portion of the shopping intent from a contextual analysis of spatial, temporal, social, and topical data associated with the request from the user.

8. The method of claim 6 wherein the request comprises data that indicates the user's physical location and wherein determining a candidate set of purchase items that satisfy the shopping intent comprises determining a candidate set of purchase items that are close in physical proximity to the user's physical location.

9. The method of claim 1 wherein the generated message that recommends to the user to purchase the selected one or more purchase items includes the total purchasing cost generated for each selected purchase item.

10. The method of claim 1 wherein one of the non-price purchasing cost factors in the set of non-price purchasing cost factors is purchase item location and wherein generating a message that recommends to the user to purchase the selected one or more purchase items comprises generating a message that includes, for at least one of the selected purchase items, a map that indicates how to travel to a location where the at least one selected purchase item is sold.

11. The method of claim 10 wherein the message indicates, as a monetized value, the cost of traveling to the location where the at least one selected purchase item is sold.

12. The method of claim 10 wherein the message includes a second map that indicates how to travel to an alternative location where the at least one selected purchase item is sold.

13. The method of claim 1 wherein the selected one or more purchase items recommended to the user includes a bundle of one or more of the selected purchase items, and wherein the bundle is associated with a unified redemption code.

14. The method of claim 1 wherein one or more of the selected one or more purchase items to recommend to the user are associated with a purchase item bundle, and wherein the purchase item bundle is associated with a unified redemption code.

15. The method of claim 14 wherein the purchase item bundle is associated with one or more incentives from one or more retailers of the purchase items associated with the purchase item bundle, and wherein the unified redemption code associated with the purchase item bundle refers to the one or more incentives.

16. A method for recommending purchases, the method comprising:
maintaining data that represents social relationships between members of a network;
determining a shopping intent of a user, the user being a member of the network;
generating a list of recommended purchase items based on the shopping intent of the user and data that represents social relationships between the user and one or more other users that are also members of the network; and
generating a message that recommends to the user to purchase the recommended purchase items in the list of recommended purchase items;
wherein the method is performed by one or more computing devices.

17. The method of claim 16, wherein the data that represents social relationships between the user and at least one of the one or more other users indicates that the user and the at least one other user have a primary relationship with each other.

18. The method of claim 16, wherein generating a list of recommended purchase items is further based on the total purchasing cost of the recommended purchase items, wherein the total purchasing cost is based on one or more non-price purchasing cost factors.

19. A method for recommending purchases, the method comprising:
determining a shopping intent of a user;
identifying a purchase item that satisfies the shopping intent;
determining a first cost value that represents the cost of purchasing the purchase item from a particular source during a first time period;
determining second first cost value that represents the cost of purchasing the purchase item from said particular source during a second time period;
determining a recommended time period based, at least in part, on said first cost value and said second cost value; and
sending a message to the user, wherein the message recommends that said user purchase the purchase item from said particular source during the recommended time period;
wherein the method is performed by one or more computing devices.

20. The method of claim 19 wherein the recommended time period is in the future relative to the time in which the message is sent to the user.

21. A method for recommending purchases, the method comprising:
storing information that reflects the user's selection of one or more purchase items recommended to the user; sending a message to an item retailer, wherein the message alerts the item retailer of the user's selection; and
receiving, from the item retailer, information that represents (a) an offer of an incentive to the user of at least one of the one or more purchase items selected by the user and (b) one or more conditions related to the offer of the incentive;
wherein the method is performed by one or more computing devices.

22. The method of claim 21, further comprising:
sending a message to the user, wherein the message indicates (a) the offer of the incentive to the user of at least one of the one or more purchase items selected by the user and (b) the one or more conditions related to the offer of the incentive;
receiving, from the user, information that indicates that the user accepts the offer of the incentive and the one or more conditions related to the offer; and
in response to receiving information that indicates that the user accepts the offer and the one or more conditions, modifying the information that reflects the user's selection of one or more purchase items recommended to the user.

23. A computer-readable storage medium storing one or more sequences of instructions which, when executed by one or more processors, causes the one or more processors to perform the method recited in claim 1.

24. A computer-readable storage medium storing one or more sequences of instructions which, when executed by one or more processors, causes the one or more processors to perform the method recited in claim 2.

25. A computer-readable storage medium storing one or more sequences of instructions which, when executed by one or more processors, causes the one or more processors to perform the method recited in claim 3.

26. A computer-readable storage medium storing one or more sequences of instructions which, when executed by one or more processors, causes the one or more processors to perform the method recited in claim 4.

27. A computer-readable storage medium storing one or more sequences of instructions which, when executed by one or more processors, causes the one or more processors to perform the method recited in claim 5.

28. A computer-readable storage medium storing one or more sequences of instructions which, when executed by one or more processors, causes the one or more processors to perform the method recited in claim 6.

29. A computer-readable storage medium storing one or more sequences of instructions which, when executed by one or more processors, causes the one or more processors to perform the method recited in claim 7.

30. A computer-readable storage medium storing one or more sequences of instructions which, when executed by one or more processors, causes the one or more processors to perform the method recited in claim 8.

31. A computer-readable storage medium storing one or more sequences of instructions which, when executed by one or more processors, causes the one or more processors to perform the method recited in claim 9.

32. A computer-readable storage medium storing one or more sequences of instructions which, when executed by one or more processors, causes the one or more processors to perform the method recited in claim 10.

33. A computer-readable storage medium storing one or more sequences of instructions which, when executed by one or more processors, causes the one or more processors to perform the method recited in claim 11.

34. A computer-readable storage medium storing one or more sequences of instructions which, when executed by one or more processors, causes the one or more processors to perform the method recited in claim 12.

35. A computer-readable storage medium storing one or more sequences of instructions which, when executed by one or more processors, causes the one or more processors to perform the method recited in claim 13.

36. A computer-readable storage medium storing one or more sequences of instructions which, when executed by one or more processors, causes the one or more processors to perform the method recited in claim 14.

37. A computer-readable storage medium storing one or more sequences of instructions which, when executed by one or more processors, causes the one or more processors to perform the method recited in claim 15.

38. A computer-readable storage medium storing one or more sequences of instructions which, when executed by one or more processors, causes the one or more processors to perform the method recited in claim 16.

39. A computer-readable storage medium storing one or more sequences of instructions which, when executed by one or more processors, causes the one or more processors to perform the method recited in claim 17.

40. A computer-readable storage medium storing one or more sequences of instructions which, when executed by one or more processors, causes the one or more processors to perform the method recited in claim 18.

41. A computer-readable storage medium storing one or more sequences of instructions which, when executed by one or more processors, causes the one or more processors to perform the method recited in claim 19.

42. A computer-readable storage medium storing one or more sequences of instructions which, when executed by one or more processors, causes the one or more processors to perform the method recited in claim 20.

43. A computer-readable storage medium storing one or more sequences of instructions which, when executed by one or more processors, causes the one or more processors to perform the method recited in claim 21.

44. A computer-readable storage medium storing one or more sequences of instructions which, when executed by one or more processors, causes the one or more processors to perform the method recited in claim 22.

45. The method of claim 1, further comprising:
maintaining data that represents degrees of social relationships between members of a network, the user being a member of the network; and
wherein selecting one or more purchase items, from the candidate set of purchase items, to recommend to the user is based on data that represents degrees of social relationships between the user and one or more other users that are also members of the network.

46. The method of claim 1, further comprising:
determining a first cost value that represents the cost of purchasing a purchase item from a particular source during a first time period;
determining second cost value that represents the cost of purchasing a purchase item from said particular source during a second time period;
determining a recommended time period based, at least in part, on said first cost value and said second cost value; and
wherein the message recommends that said user purchase the purchase item from said particular source during the recommended time period.

47. The method of claim 1, further comprising:
storing information that reflects the user's selection of one or more of the selected one or more purchase items recommended to the user;
sending a notification message to an item retailer, wherein the notification message alerts the item retailer of the user's selection; and
receiving, from the item retailer, information that represents (a) an offer of an incentive to the user of at least one of the one or more purchase items selected by the user and (b) one or more conditions related to the offer of the incentive.

48. A computer-readable storage medium storing one or more sequences of instructions which, when executed by one or more processors, causes the one or more processors to perform the method recited in claim 45.

49. A computer-readable storage medium storing one or more sequences of instructions which, when executed by one or more processors, causes the one or more processors to perform the method recited in claim 46.

50. A computer-readable storage medium storing one or more sequences of instructions which, when executed by one or more processors, causes the one or more processors to perform the method recited in claim 47.
